(19) United States
(12) Patent Application Publication
(10) Pub. No.: US 2026/0226945 A1
(43) Pub. Date: Aug. 6, 2026

(54) SLIDING MEMBER AND ROLLING BEARING

(71) Applicants: JTEKT CORPORATION, Kariya-shi, Aichi (JP); JTEKT SEALING TECHNO CORPORATION, Itano-gun, Tokushima (JP)

(72) Inventors: Yasuhiko ISHII, Kashiwara-shi (JP); Takashi HARA, Itano-gun (JP); Ikuo YAMAMOTO, Kashiwara-shi (JP)

(73) Assignees: JTEKT CORPORATION, Kariya-shi, Aichi (JP); JTEKT SEALING TECHNO CORPORATION, Itano-gun, Tokushima (JP)

(21) Appl. No.: 19/149,779

(22) PCT Filed: Apr. 27, 2023
(86) PCT No.: PCT/JP2023/016610

§ 371 Date: Jul. 21, 2025

(30) Foreign Application Priority Data
Feb. 24, 2023 (JP) 2023-027502

(51) Int. Cl. F16C 33/78; F16C 41/00

(52) U.S. Cl. CPC F16C 33/7886; F16C 41/002

(57) ABSTRACT

A sliding member includes a sheet, a metal ring, and a rubber. The sheet is made of conductive fibers, is fixed in contact with a first member made of a steel material, and is in slidable contact with a second member made of a steel material. The metal ring includes a first circumferential surface disposed to be oriented to a first radial side and extending in an axial direction, and a second circumferential surface disposed to be oriented to a second radial side and extending in the axial direction. The rubber includes at least a second rubber portion out of a first rubber portion fixed to the first circumferential surface, and the second rubber portion fixed to the second circumferential surface. The sheet includes a sheet portion fixed to the second rubber portion. In the sliding member, a first surface on the first radial side is the first circumferential surface or a surface of the first rubber portion on the first radial side, and a second surface on the second radial side is a surface of the second rubber portion on the second radial side and/or a surface of the sheet portion on the second radial side. In the sliding member, a first thickness is a thickness from the first circumferential surface to the first surface, and a second thickness is a thickness from the second circumferential surface to the second surface. The second thickness is larger than the first thickness.

### TECHNICAL FIELD

The present disclosure relates to a sliding member and a rolling bearing.

### BACKGROUND ART

A rolling bearing having an electrolytic corrosion prevention function is disclosed in Patent Document 1. The rolling bearing described in Patent Document 1 is a bearing that supports a rotary shaft of an electric motor mounted on an electrified vehicle etc. This rolling bearing includes an outer ring, an inner ring, a plurality of balls disposed between the outer ring and the inner ring, and annular seals (sliding members) that close the end openings of an intra-bearing space between the outer ring and the inner ring. The seal includes a conductive elastic member such as rubber. The inner circumferential edge and the outer circumferential edge of this elastic member are in contact with the inner ring and the outer ring, respectively. Since the elastic member is in contact with the inner ring and the outer ring, the inner ring is electrically connected to the outer ring through the elastic member, a current flow is suppressed between the inner ring and the balls and between the outer ring and the balls, and electrolytic corrosion is suppressed on the raceway of the inner ring, the raceway of the outer ring, and the balls.

### RELATED ART DOCUMENTS

### Patent Documents

Patent Document 1: Japanese Unexamined Patent Application Publication No. 2015-102200 (JP 2015-102200 A)

### SUMMARY OF THE INVENTION

### Problem to Be Solved by the Invention

The elastic member of the seal (sliding member) in Patent Document 1 has a certain degree of electrical conductivity by carbon fiber kneaded into the rubber. There is a demand to further increase the electrical conductivity of the seal in order to further suppress the electrolytic corrosion of the raceway. Therefore, an object of the present disclosure is to increase the electrical conductivity of a sliding member.

### Means for Solving the Problem

(1) A sliding member according to the present disclosure includes a sheet, a metal ring, and a rubber. The sheet is made of conductive fibers, is fixed in contact with a first member made of a steel material, and is in slidable contact with a second member made of a steel material. The metal ring includes a first circumferential surface disposed to be oriented to a first radial side and extending in an axial direction, and a second circumferential surface disposed to be oriented to a second radial side and extending in the axial direction. The rubber includes at least a second rubber portion out of: a first rubber portion fixed to the first circumferential surface; and the second rubber portion fixed to the second circumferential surface. The sheet includes a sheet portion fixed to the second rubber portion. A first surface on the first radial side is the first circumferential surface or a surface of the first rubber portion on the first radial side. A second surface on the second radial side is a surface of the second rubber portion on the second radial side and/or a surface of the sheet portion on the second radial side. A first thickness is a thickness from the first circumferential surface to the first surface. A second thickness is a thickness from the second circumferential surface to the second surface. The second thickness is larger than the first thickness.

(2) A sliding member according to the present disclosure includes a sheet, a metal ring, and a rubber. The sheet is made of conductive fibers, is fixed in contact with a first member made of a steel material, and is in slidable contact with a second member made of a steel material. The metal ring includes a first circumferential surface disposed to be oriented to a first radial side and extending in an axial direction, and a second circumferential surface disposed to be oriented to a second radial side and extending in the axial direction. The rubber includes at least a second rubber portion and a plurality of third rubber portions out of: a plurality of first rubber portions fixed to the first circumferential surface and disposed at spacings in a circumferential direction; the second rubber portion fixed to the second circumferential surface; and the third rubber portions each fixed to the first circumferential surface between the circumferentially adjacent first rubber portions. The sheet includes a sheet portion fixed to the second rubber portion. A first surface on the first radial side is the first circumferential surface or a surface of each of the first rubber portions on the first radial side. A second surface on the second radial side is a surface of the second rubber portion on the second radial side and/or a surface of the sheet portion on the second radial side. A third surface on the first radial side is a surface of each of the third rubber portions on the first radial side. A first thickness is a thickness from the first circumferential surface to the first surface. A second thickness is a thickness from the second circumferential surface to the second surface. A third thickness is a thickness from the first circumferential surface to the third surface. The second thickness is larger than the first thickness. The third thickness is larger than the first thickness.

(3) A rolling bearing according to the present disclosure includes: an inner ring including an inner ring raceway; an outer ring including an outer ring raceway disposed on a radially outer side relative to the inner ring raceway; a plurality of rolling elements rotatably disposed between the inner ring raceway and the outer ring raceway; and the sliding member according to (1) or (2) that is disposed between an axial end of the inner ring and an axial end of the outer ring in a radial direction. One of the inner ring and the outer ring is the first member. The other of the inner ring and the outer ring is the second member.

### Effects of the Invention

The sliding member according to the present disclosure includes the sheet that is a nonwoven or woven fabric made of the conductive fibers. The sheet can have a smaller electrical resistance and a higher electrical conductivity than an elastic member in which carbon fibers are kneaded into rubber. Thus, the sliding member electrically connects the first member and the second member via the sheet, and a current can flow from one of the first member and the second member to the other via the sheet.

### BRIEF DESCRIPTION OF THE DRAWINGS

FIG. 1 is a sectional view showing an example of a rolling bearing of the present disclosure.

FIG. 2 is an enlarged sectional view of a sliding member.

FIG. 3 is an enlarged sectional view of a radially outer portion of the sliding member in FIG. 2.

FIG. 4 is an enlarged sectional view of a radially inner portion of the sliding member in FIG. 2.

FIG. 5A is a diagram of part of the sliding member in a circumferential direction as viewed in an axial direction from an extra-bearing space side.

FIG. 5B is a sectional view taken along line A-A in FIG. 5A.

FIG. 5C is a sectional view taken along line B-B in FIG. 5A.

FIG. 6 is a sectional view showing a molding die for the sliding member.

FIG. 7 is an enlarged sectional view showing part of the molding die for the sliding member.

FIG. 8 is an enlarged sectional view showing part of the molding die in an open state.

### MODES FOR CARRYING OUT THE INVENTION

### Overview of Embodiments of Invention of Present Disclosure

An overview of embodiments of the invention of the present disclosure will be provided below.

(1) A sliding member according to the present disclosure includes a sheet, a metal ring, and a rubber. The sheet is made of conductive fibers, is fixed in contact with a first member made of a steel material, and is in slidable contact with a second member made of a steel material. The metal ring includes a first circumferential surface disposed to be oriented to a first radial side and extending in an axial direction, and a second circumferential surface disposed to be oriented to a second radial side and extending in the axial direction. The rubber includes at least a second rubber portion out of: a first rubber portion fixed to the first circumferential surface; and the second rubber portion fixed to the second circumferential surface. The sheet includes a sheet portion fixed to the second rubber portion. A first surface on the first radial side is the first circumferential surface or a surface of the first rubber portion on the first radial side. A second surface on the second radial side is a surface of the second rubber portion on the second radial side and/or a surface of the sheet portion on the second radial side. A first thickness is a thickness from the first circumferential surface to the first surface. A second thickness is a thickness from the second circumferential surface to the second surface. The second thickness is larger than the first thickness.

In this configuration, the sliding member includes the sheet that is a nonwoven or woven fabric made of the conductive fibers. The sheet can have a smaller electrical resistance and a higher electrical conductivity than an elastic member in which carbon fibers are kneaded into rubber. Thus, the sliding member electrically connects the first member and the second member via the sheet, and a current can flow from one of the first member and the second member to the other via the sheet.

The second thickness of the sliding member is larger than the first thickness. A die for molding the sliding member having such a configuration has a structure for regulating the position of the metal ring from the first radial side. Thus, it is possible to suppress misalignment of the metal ring relative to the die in the radial direction.

(2) A sliding member according to the present disclosure includes a sheet, a metal ring, and a rubber. The sheet is made of conductive fibers, is fixed in contact with a first member made of a steel material, and is in slidable contact with a second member made of a steel material. The metal ring includes a first circumferential surface disposed to be oriented to a first radial side and extending in an axial direction, and a second circumferential surface disposed to be oriented to a second radial side and extending in the axial direction. The rubber includes at least a second rubber portion and a plurality of third rubber portions out of: a plurality of first rubber portions fixed to the first circumferential surface and disposed at spacings in a circumferential direction; the second rubber portion fixed to the second circumferential surface; and the third rubber portions each fixed to the first circumferential surface between the circumferentially adjacent first rubber portions. The sheet includes a sheet portion fixed to the second rubber portion. A first surface on the first radial side is the first circumferential surface or a surface of each of the first rubber portions on the first radial side. A second surface on the second radial side is a surface of the second rubber portion on the second radial side and/or a surface of the sheet portion on the second radial side. A third surface on the first radial side is a surface of each of the third rubber portions on the first radial side. A first thickness is a thickness from the first circumferential surface to the first surface. A second thickness is a thickness from the second circumferential surface to the second surface. A third thickness is a thickness from the first circumferential surface to the third surface. The second thickness is larger than the first thickness. The third thickness is larger than the first thickness.

In this configuration, the sliding member includes the sheet that is a nonwoven or woven fabric made of the conductive fibers. The sheet can have a smaller electrical resistance and a higher electrical conductivity than an elastic member in which carbon fibers are kneaded into rubber. Thus, the sliding member electrically connects the first member and the second member via the sheet, and a current can flow from one of the first member and the second member to the other via the sheet.

The second thickness and the third thickness of the sliding member are larger than the first thickness. A die for molding the sliding member having such a configuration has a structure for regulating the position of the metal ring from the first radial side partially in the circumferential direction. Thus, it is possible to suppress misalignment of the metal ring relative to the die in the radial direction.

(3) Preferably, the metal ring of the sliding member according to (1) or (2) is disposed at a spacing from the sheet on a first axial side, and the rubber includes a portion disposed in the spacing.

In this configuration, the metal ring and the sheet are not in direct contact with each other, and damage to the sheet due to a load applied from the metal ring is suppressed.

(4) Preferably, the rubber of the sliding member according to any one of (1) to (3) is bonded to the entire sheet on a first axial side.

With this configuration, the overall shape of the sheet can be maintained by the rubber.

(5) A rolling bearing according to the present disclosure includes: an inner ring including an inner ring raceway; an outer ring including an outer ring raceway disposed on a radially outer side relative to the inner ring raceway; a plurality of rolling elements rotatably disposed between the inner ring raceway and the outer ring raceway; and the sliding member according to any one of (1) to (4) that is disposed between an axial end of the inner ring and an axial end of the outer ring in a radial direction. One of the inner ring and the outer ring is the first member. The other of the inner ring and the outer ring is the second member.

With this configuration, the outer ring and the inner ring of the rolling bearing can be electrically connected by the sheet of the sliding member, and a current can flow from one of the outer ring and the inner ring to the other via the sheet, thereby suppressing electrolytic corrosion of the outer ring raceway, the inner ring raceway, and the balls.

### Details of Embodiments of Invention of Present Disclosure

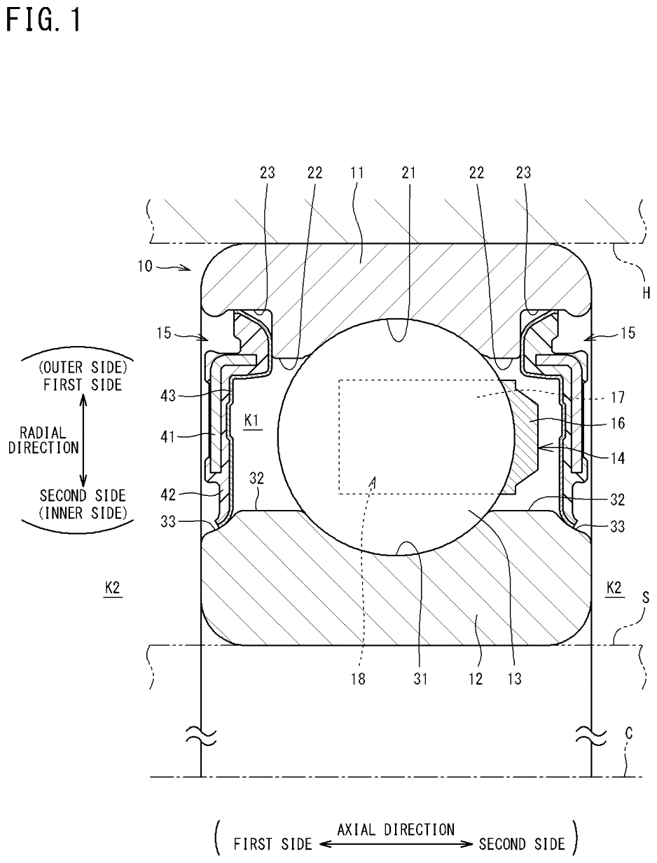

Hereinafter, the embodiments of the invention of the present disclosure will be described. FIG. 1 is a sectional view showing an example of a rolling bearing of the present disclosure. A rolling bearing 10 shown in FIG. 1 supports a rotary shaft S of a motor mounted on, for example, a battery electric vehicle or a hybrid electric vehicle. In FIG. 1, the rotary shaft S is shown in hidden outline (long dashed double-short dashed line).

The rolling bearing 10 includes an outer ring 11, an inner ring 12, a plurality of rolling elements 13, a cage 14, and sliding members 15. In the present embodiment, the rolling elements 13 are balls. The rolling bearing 10 is a deep groove ball bearing. The outer ring 11 is attached to a housing H of the motor. The inner ring 12 is fitted and fixed to the outer circumferential surface of the rotary shaft S. In FIG. 1, the housing H is shown in hidden outline (long dashed double-short dashed line). In the present embodiment, the outer ring 11 is a fixed ring, and the inner ring 12 is a rotary ring. The outer ring 11 and the inner ring 12 are made of steel materials such as bearing steel. As the bearing steel, high carbon chromium bearing steel (e.g., SUJ2 or SUJ3 specified in the JIS standard) can be adopted. However, the outer ring 11 and the inner ring 12 may be made of other steel materials such as carburized bearing steel, carbon steel, chromium steel, or stainless steel.

The outer ring 11 and the inner ring 12 are disposed concentrically. In the present embodiment, the central axis of the outer ring 11 and the central axis of the inner ring 12 coincide with a central axis C of the rolling bearing 10. In the present embodiment, a direction along the central axis C and a direction parallel to the central axis C are defined as “axial direction.” Similarly, a direction orthogonal to the central axis C is defined as “radial direction.” Similarly, a direction along a circle about the central axis C is defined as “circumferential direction.” In the present embodiment, the left side in FIG. 1 is a first axial side, the right side in FIG. 1 is a second axial side, the upper side in FIG. 1 is a first radial side, and the lower side in FIG. 1 is a second radial side. In the present embodiment, the first radial side is a radially outer side, and the second radial side is a radially inner side. Therefore, in the following description, the first radial side may be referred to as the radially outer side, and the second radial side may be referred to as the radially inner side.

The outer ring 11 includes an outer ring raceway 21, two shoulders 22, and two annular grooves 23. The outer ring raceway 21 is provided on the inner circumferential surface of the outer ring 11. The balls 13 roll along the outer ring raceway 21. The two shoulders 22 are provided on both axial sides of the outer ring raceway 21. The two annular grooves 23 are provided between the shoulders 22 and the faces of the outer ring 11, respectively. The annular groove 23 has a circumferentially continuous annular groove shape. The sliding members 15 are attached to the annular grooves 23 disposed on both axial sides of the outer ring 11. However, the sliding member 15 may be attached only to the annular groove 23 disposed on one of the first axial side and the second axial side of the outer ring 11. In this case, the annular groove 23 to which the sliding member 15 is not attached may be omitted.

The inner ring 12 includes an inner ring raceway 31, two shoulders 32, and two sliding member contact surfaces 33. The inner ring raceway 31 is provided on the outer circumferential surface of the inner ring 12. The balls 13 roll along the inner ring raceway 31. The two shoulders 32 are provided on both axial sides of the inner ring raceway 31. The two sliding member contact surfaces 33 are provided between the shoulders 32 and the faces of the inner ring 12, respectively. The sliding member contact surface 33 is provided annularly on the entire circumference of the inner ring 12. The sliding member contact surface 33 has a groove shape in a cross section including the central axis C of the inner ring 12. The radially inner end of the sliding member 15 is in contact with the sliding member contact surface 33.

The balls 13 are disposed between the outer ring 11 and the inner ring 12. The balls 13 are in rolling contact with the outer ring raceway 21 and the inner ring raceway 31. The plurality of balls 13 is held with spacings in the circumferential direction by the annular cage 14.

The cage 14 includes an annular body 16 and a plurality of prongs (cage bars) 17. The annular body 16 is provided on the second axial side of the balls 13. The plurality of prongs (cage bars) 17 is provided to extend from the annular body 16 to the first axial side. Pockets 18 are each a space between two circumferentially adjacent prongs 17 on the first axial side of the annular body 16. The balls 13 are housed in the pockets 18. The pockets 18 are open on the first axial side.

The sliding member 15 has an annular shape. The sliding member 15 is attached and fixed to the outer ring (first member) 11, and is in sliding contact with the inner ring (second member) 12. Specifically, the sliding member 15 is fixed to the outer ring 11 by fitting its radially outer end (end on the first radial side) to the annular groove 23 of the outer ring 11. The radially inner end (end on the second radial side) of the sliding member 15 is in contact with the sliding member contact surface 33 of the inner ring 12. The sliding members 15 are disposed on both axial sides of the rolling bearing 10. Therefore, an intra-bearing space K1 that is an annular space between the outer ring 11 and the inner ring 12 and in which the balls 13 are present is closed by the sliding members 15 on both axial sides. The sliding members 15 separate the intra-bearing space K1 in which the balls 13 are present from extra-bearing spaces K2 that are spaces on the first axial side and the second axial side relative to the rolling bearing 10.

The sliding member 15 includes a conductive sheet 43 disposed between the radially outer end and the radially inner end. At the radially outer end of the sliding member 15, the sheet 43 is exposed on the surface and is in contact with the annular groove 23 of the outer ring 11. At the radially inner end of the sliding member 15, the sheet 43 is exposed on the surface and is in contact with the sliding member contact surface 33 of the inner ring 12. Therefore, the sliding member 15 forms a current path for suppressing a flow of a current generated by the motor etc. between the outer ring 11 and the inner ring 12 via the rolling elements 13.

Oil films made of lubricating oil or grease are formed between the balls 13 and the inner ring raceway 31 and between the balls 13 and the outer ring raceway 21. The oil films have insulating properties. Due to the insulating properties of the oil films, the balls 13 are insulated from the inner ring raceway 31 and from the outer ring raceway 21. When the oil film is formed between the balls 13 and the inner ring raceway 31 and a potential difference of a predetermined value or less occurs between the balls 13 and the inner ring raceway 31, no current flows between the inner ring raceway 31 and the balls 13. When the oil film is formed between the balls 13 and the outer ring raceway 21 and a potential difference of a predetermined value or less occurs between the balls 13 and the outer ring raceway 21, no current flows between the balls 13 and the outer ring raceway 21. When the oil film between the balls 13 and the inner ring raceway 31 is partially destroyed or when a potential difference exceeding the predetermined value occurs between the balls 13 and the inner ring raceway 31, however, a current flows between the balls 13 and the inner ring raceway 31, and the current may cause electrolytic corrosion of the balls 13 and/or the inner ring raceway 31. When the oil film between the balls 13 and the outer ring raceway 21 is partially destroyed or when a potential difference exceeding the predetermined value occurs between the balls 13 and the outer ring raceway 21, a current flows between the balls 13 and the outer ring raceway 21, and the current may cause electrolytic corrosion of the balls 13 and/or the outer ring raceway 21.

Since the rolling bearing 10 of the present embodiment includes the sliding member 15 that forms the current path, the potential difference between the outer ring 11 and the inner ring 12 is reduced by causing a current to flow between the outer ring 11 and the inner ring 12 via the sliding member 15 before the potential difference between the balls 13 and the inner ring raceway 31 and the potential difference between the balls 13 and the outer ring raceway 21 increase. By reducing the potential difference between the outer ring 11 and the inner ring 12, the occurrence of electrolytic corrosion of the balls 13, the inner ring raceway 31, and the outer ring raceway 21 is suppressed.

### [Specific Structure of Sliding Member 15]

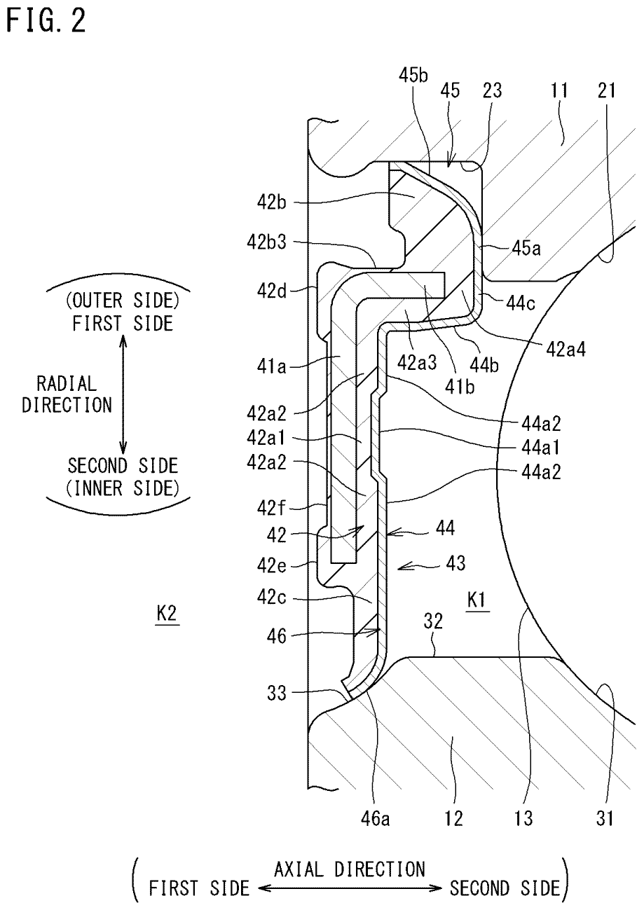

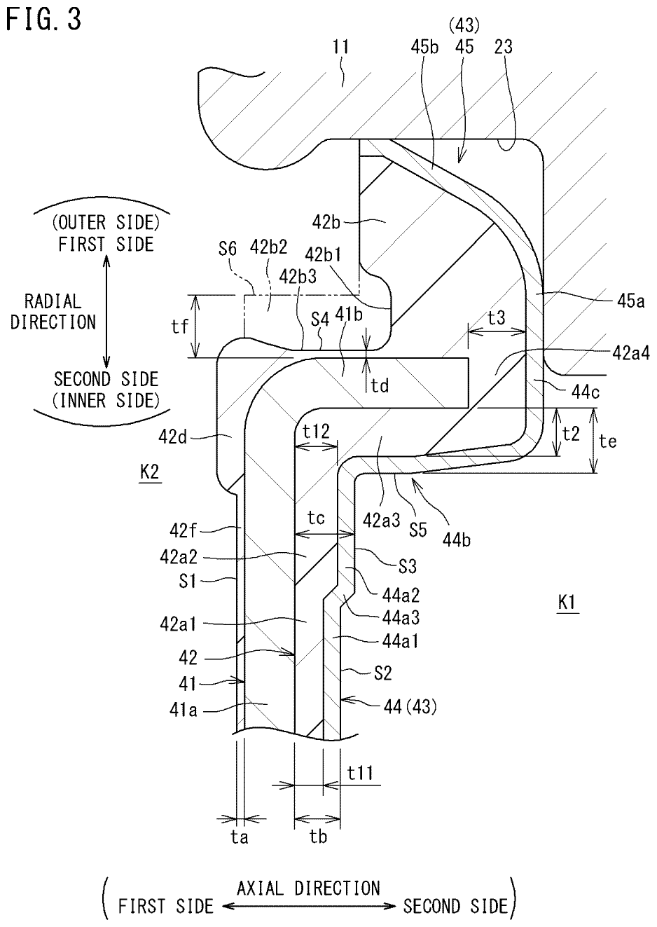

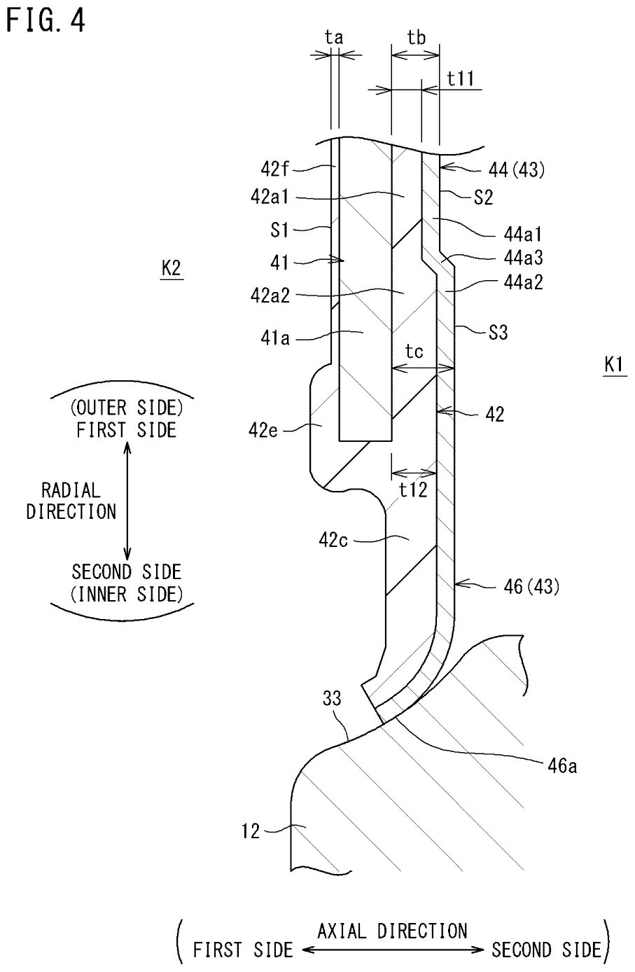

FIG. 2 is an enlarged sectional view of the sliding member. FIG. 3 is an enlarged sectional view of a radially outer portion of the sliding member in FIG. 2. FIG. 4 is an enlarged sectional view of a radially inner portion of the sliding member in FIG. 2. In the following description, a specific structure of the sliding member 15 disposed on the first axial side (left side in FIG. 1) of the rolling bearing 10 will be described. Therefore, in the description of the sliding member 15, the first axial side can be rephrased as the extra-bearing space K2 side, and the second axial side can be rephrased as the intra-bearing space K1 side. The sliding member 15 disposed on the second axial side (right side in FIG. 1) of the rolling bearing 10 is the same component as the sliding member 15 disposed on the first axial side, but is disposed while being inverted in the axial direction.

As shown in FIGS. 2 to 4, the sliding member 15 includes a metal ring 41, a rubber 42, and the sheet 43. All of the metal ring 41, the rubber 42, and the sheet 43 have annular shapes. The metal ring 41 and the rubber 42 are bonded to each other, and the rubber 42 and the sheet 43 are bonded to each other. They are integrated as a whole.

The metal ring 41 is made of a metal such as a zinc-plated steel sheet or stainless steel. The metal ring 41 is formed by processing a plate material. The metal ring 41 includes an annular portion 41a having an annular shape, and a cylindrical portion 41b having a cylindrical shape. The annular portion 41a is disposed perpendicular to the axial direction. The cylindrical portion 41b is disposed parallel to the axial direction. The cylindrical portion 41b is disposed at the radially outer end of the annular portion 41a. The cylindrical portion 41b extends from the radially outer end of the annular portion 41a to the second axial side (intra-bearing space K1 side). The annular portion 41a and the cylindrical portion 41b of the metal ring 41 are formed by plastically processing a plate material into a substantial L-shape in cross section.

The rubber 42 has electrical conductivity. Specifically, the rubber 42 is produced by, for example, compounding a conductive material with synthetic rubber. The conductive material is carbon black, metal powder, etc. The specific structure of the rubber 42 will be described later together with the structure of the sheet 43.

The sheet 43 is made of a nonwoven or woven fabric made of conductive fibers as a raw material. In the present embodiment, the conductive fibers used for the sheet 43 are carbon fibers. However, the conductive fibers may be fibers made of other materials, for example, conductive metals such as copper and nickel. The electrical resistance of the sheet 43 is lower than the electrical resistance of the rubber 42. Therefore, the sheet 43 has a higher electrical conductivity than the rubber 42.

In the present embodiment, the sheet 43 further contains a synthetic resin as a binder. The binder is fixed to the surface of part of the conductive fibers contained in the sheet 43. The sheet 43 of the present embodiment is the nonwoven or woven fabric made of the conductive fibers with the binder fixed thereto.

The sheet 43 integrally includes a middle portion 44, a fixed portion 45, and a sliding portion 46. The fixed portion 45 is a portion disposed on the radially outer side (first radial side) relative to the metal ring 41. The sliding portion 46 is a portion disposed on the radially inner side (second radial side) relative to the metal ring 41. The middle portion 44 is a portion disposed between the fixed portion 45 and the sliding portion 46.

The middle portion 44 of the sheet 43 includes a first portion 44a1, second portions 44a2, a third portion 44b, and a fourth portion 44c. The first portion 44a1 and the second portions 44a2 extend in the radial direction. As shown in FIGS. 3 and 4, the first portion 44a1 and the second portions 44a2 are disposed at spacings t11, t12 on the second axial side (intra-bearing space K1 side) from the annular portion 41a of the metal ring 41.

The second portions 44a2 are disposed on both radial sides of the first portion 44a1. In other words, the first portion 44a1 is positioned midway in the radial direction along the second portion 44a2. The first portion 44a1 and the second portions 44a2 are connected in the radial direction. The first portion 44a1 is positioned on the first axial side (extra-bearing space K2 side) relative to the second portions 44a2. Therefore, the spacing t11 between the first portion 44a1 and the metal ring 41 is smaller than the spacing t12 between the second portion 44a2 and the metal ring 41. A step portion 44a3 is provided at the boundary between the first portion 44a1 and the second portion 44a2.

As shown in FIGS. 2 and 3, the third portion 44b of the sheet 43 is bent from the radially outer end of the second portion 44a2 to the second axial side, and extends substantially in the axial direction. Therefore, the third portion 44b has a substantially cylindrical shape. As shown in FIG. 3, the third portion 44b is disposed at a spacing t2 on the radially inner side from the cylindrical portion 41b of the metal ring 41.

The fourth portion 44c is bent radially outward from the end of the third portion 44b on the second axial side, and extends in the radial direction. As shown in FIG. 3, the fourth portion 44c is disposed at a spacing t3 on the second axial side from the cylindrical portion 41b of the metal ring 41. Therefore, the middle portion 44 of the sheet 43 and the metal ring 41 are entirely disposed at the spacings t11, t12, t2, t3 therebetween in the radial direction.

The fixed portion 45 of the sheet 43 is continuous with the fourth portion 44c of the middle portion 44. As shown in FIG. 3, the fixed portion 45 includes a fifth portion 45a and a sixth portion 45b. The fifth portion 45a extends in the radial direction continuously from the radially outer end of the fourth portion 44c of the middle portion 44. The sixth portion 45b extends from the radially outer end of the fifth portion 45a while being inclined to the first axial side and the radially outer side. The tip of the sixth portion 45b constitutes the radially outer end of the sheet 43. The tip of the sixth portion 45b is in direct contact with the annular groove 23 of the outer ring 11. In the present embodiment, the fifth portion 45a of the fixed portion 45 is also in direct contact with the annular groove 23.

As shown in FIGS. 2 and 4, the sliding portion 46 of the sheet 43 is continuous with the second portion 44a2 that is the middle portion 44. In the present embodiment, a portion of the sheet 43 that is disposed on the radially inner side relative to the radially inner end of the metal ring 41 serves as the sliding portion 46. The sliding portion 46 linearly extends radially inward from the second portion 44a2 of the middle portion 44. Therefore, the second portion 44a2 of the middle portion 44 and the sliding portion 46 as a whole have an annular shape perpendicular to the axial direction. A radially inner end 46a of the sliding portion 46 is in direct contact with the sliding member contact surface 33 of the inner ring 12. The radially inner end 46a of the sliding portion 46 is bent to the first axial side by the contact with the sliding member contact surface 33.

As shown in FIG. 2, the rubber 42 is bonded to the sheet 43 and the metal ring 41. The rubber 42 is provided over the entire sheet 43 on the first axial side (extra-bearing space K2 side). The rubber 42 includes a first portion 42a1, second portions 42a2, a third portion 42a3, a fourth portion 42a4, a fifth portion 42b, a sixth portion 42c, a seventh portion 42d, an eighth portion 42e, a ninth portion 42f, a tenth portion 42b2, and an eleventh portion 42b3.

The first to fourth portions 42a1, 42a2, 42a3, 42a4 of the rubber 42 are disposed in the spacings t11, t12, t2, t3 between the metal ring 41 and the sheet 43. The first to fourth portions 42a1, 42a2, 42a3, 42a4 of the rubber 42 maintain the spacings t11, t12, t2, t3 between the metal ring 41 and the sheet 43 such that the metal ring 41 and the sheet 43 are not directly bonded to each other.

The first portion 42a1 of the rubber 42 is a portion of the rubber 42 to which the first portion 44a1 of the sheet 43 is bonded. The second portions 42a2 are portions of the rubber 42 to which the second portions 44a2 of the sheet 43 are bonded. Therefore, the second portions 42a2 are disposed on both radial sides of the first portion 42a1.

The surface of the first portion 42a1 on the first axial side (extra-bearing space K2 side) and the surface of the second portion 42a2 on the first axial side are disposed on the same plane, and both are bonded to the surface of the annular portion 41a of the metal ring 41 on the second axial side (intra-bearing space K1 side). The surface of the first portion 42al on the second axial side is disposed on the first axial side relative to the surface of the second portion 42a2 on the second axial side.

The first portion 42a1 of the rubber 42 and the first portion 44a1 of the sheet 43 are continuous in the circumferential direction over the entire circumference of the sliding member 15. However, these may be provided at a plurality of positions with spacings in the circumferential direction.

The third portion 42a3 of the rubber 42 is bonded to the inner circumferential surface of the cylindrical portion 41b of the metal ring 41. The fourth portion 42a4 of the rubber 42 is bonded to the end face of the cylindrical portion 41b on the second axial side. The fifth portion 42b of the rubber 42 is continuous with the fourth portion 42a4 on the radially outer side. The fifth portion 42b is disposed in a region surrounded by the fixed portion 45 of the sheet 43 and the cylindrical portion 41b of the metal ring 41. The fifth portion 42b of the rubber 42 elastically supports the sixth portion 45b of the sheet 43 from the radially inner side. The cylindrical portion 41b of the metal ring 41 supports the fifth portion 42b of the rubber 42 from the radially inner side. Therefore, the fixed portion (radially outer end) 45 of the sheet 43 is pressed against the annular groove 23 of the outer ring 11 by the elasticity of the fifth portion 42b of the rubber 42 supported by the cylindrical portion 41b of the metal ring 41, and is securely brought into contact with the annular groove 23.

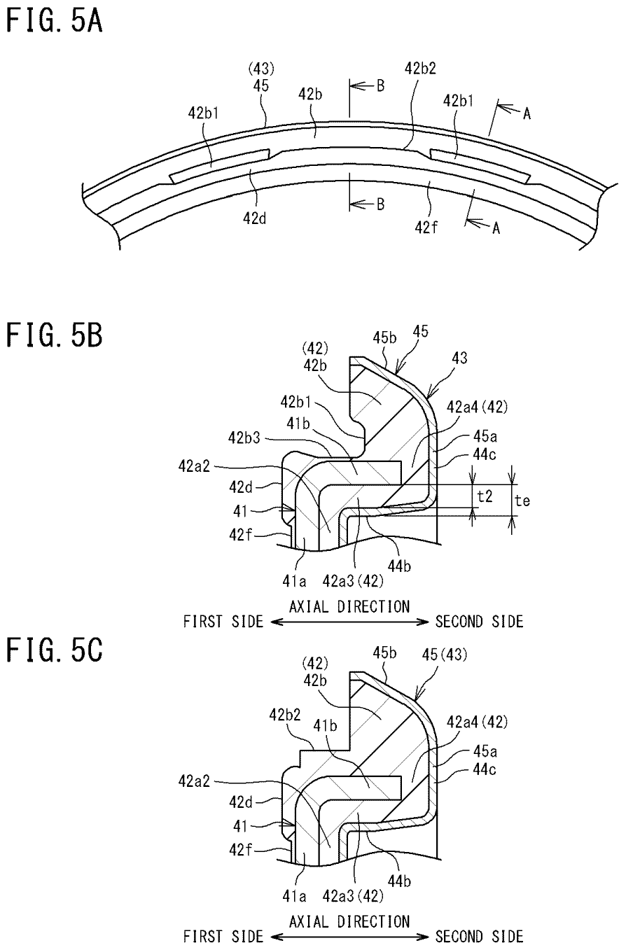

FIG. 5A is a diagram of part of the sliding member in the circumferential direction as viewed in the axial direction from the extra-bearing space side. FIG. 5B is a sectional view taken along line A-A in FIG. 5A. FIG. 5C is a sectional view taken along line B-B in FIG. 5A. The fifth portion 42b of the rubber 42 has recesses 42b1 on the surface on the first axial side. The recesses 42b1 are provided at a plurality of positions with spacings in the circumferential direction. As shown in FIG. 5B, at the circumferential position where the recess 42b1 is provided, part of the outer circumferential surface of the cylindrical portion 41b of the metal ring 41 is covered with the thin film-shaped eleventh portion 42b3. As shown in FIG. 5C, between the circumferentially adjacent recesses 42b1, part of the outer circumferential surface of the cylindrical portion 41b of the metal ring 41 is covered with the tenth portion 42b2 thicker than the eleventh portion 42b3. Although the recesses 42b1 are provided at the plurality of positions with spacings in the circumferential direction, they may be provided continuously over the entire circumference of the sliding member 15. In this case, the eleventh portion 42b3 is provided on the entire circumference of the sliding member 15.

As shown in FIG. 4, the sixth portion 42c of the rubber 42 extends radially inward from the radially inner end of the second portion 42a2 of the rubber 42. The sixth portion 42c is provided with a substantially constant thickness along the face of the sliding portion 46 of the sheet 43 on the first axial side. The sixth portion 42c has an annular shape perpendicular to the axial direction. When the radially inner end 46a of the sliding portion 46 of the sheet 43 is bent in contact with the sliding member contact surface 33, the sixth portion 42c of the rubber 42 is elastically deformed and bent to the first axial side together with the sliding portion 46.

As shown in FIG. 3, the seventh portion 42d of the rubber 42 bulges from the tenth portion 42b2 and the eleventh portion 42b3 of the rubber 42 to the first axial side, covers the surface of the annular portion 41a of the metal ring 41 on the first radial side and the first axial side, and is bonded to the surface. The seventh portion 42d is continuous in the circumferential direction over the entire circumference of the sliding member 15. However, the seventh portion 42d may be provided at a plurality of positions with spacings in the circumferential direction.

As shown in FIG. 4, the eighth portion 42e of the rubber 42 is disposed on the face of the metal ring 41 on the first axial side while extending over the radially inner end of the metal ring 41 from the radially outer end of the sixth portion 42c. Therefore, the eighth portion 42e has a substantial L-shape in cross section, covers the radially inner end face of the annular portion 41a and its face on the first axial side, and is bonded to these faces. The eighth portion 42e is continuous in the circumferential direction over the entire circumference of the sliding member 15. However, the eighth portion 42e may be provided at a plurality of positions with spacings in the circumferential direction.

The seventh portion 42d and the eighth portion 42e of the rubber 42 serve to firmly bond the rubber 42 and the metal ring 41 together, and restrain the rubber 42 from falling off the metal ring 41.

As shown in FIGS. 3 and 4, the ninth portion (first rubber portion) 42f of the rubber 42 is a thin film-shaped portion that covers the surface of the annular portion 41a of the metal ring 41 on the first axial side. The ninth portion 42f is disposed between the seventh portion 42d and the eighth portion 42e in the radial direction. The radially outer end of the ninth portion 42f is integral with the seventh portion 42d. The radially inner end of the ninth portion 42f is integral with the eighth portion 42e.

An axial thickness ta of the ninth portion 42f is smaller than the axial thicknesses of the seventh portion 42d and the eighth portion 42e. Therefore, as shown in FIG. 2, the sliding member 15 has a shape in which part of the face on the first axial side is recessed. In the present embodiment, the ninth portion 42f is not essential and may be omitted. In this case, the face of the metal ring 41 on the first axial side is exposed to the outside (extra-bearing space K2) between the seventh portion 42d and the eighth portion 42e in the radial direction.

As shown in FIGS. 3 and 4, the sliding member 15 includes a “surface S1,” a “surface S2,” and a “surface S3” defined below.
Surface S1: the surface of the ninth portion 42f of the rubber 42 on the first axial side or the surface of the metal ring 41 on the first axial side (when the ninth portion 42f is not present)
Surface S2: the surface of the first portion 42a1 of the rubber 42 on the second axial side and/or the surface of the first portion 44a1 of the sheet 43 on the second axial side
Surface S3: the surface of the second portion 42a2 of the rubber 42 on the second axial side and/or the surface of the second portion 44a2 of the sheet 43 on the second axial side

The surface S1 and the surface S2 of the sliding member 15 are positioned to overlap each other in the radial direction and the circumferential direction. As described later, the sheet 43 has gaps between the conductive fibers, and the rubber 42 enters the gaps in the sheet 43. Therefore, the surface S2 may be constituted solely by the surface of the first portion 44a1 of the sheet 43 on the second axial side, or may be constituted, in addition to this surface, by the surface of the first portion 42a1 of the rubber 42 on the second axial side that enters the first portion 44a1. Alternatively, the surface S2 may be constituted solely by the surface of the first portion 42a1 of the rubber 42 on the second axial side that enters the gaps in the first portion 44a1 of the sheet 43 and extends beyond the first portion 44a1.

Similarly, the surface S3 may be constituted solely by the surface of the second portion 44a2 of the sheet 43 on the second axial side, or may be constituted, in addition to this surface, by the surface of the second portion 42a2 of the rubber 42 on the second axial side that enters the second portion 44a2. Alternatively, the surface S3 may be constituted solely by the surface of the second portion 42a2 of the rubber 42 on the second axial side that enters the gaps in the second portion 44a2 of the sheet 43 and extends beyond the second portion 44a2.

As shown in FIGS. 3 and 4, the sliding member 15 includes the “thickness ta,” a “thickness tb,” and a “thickness tc” defined below.
Thickness ta: the thickness from the surface of the metal ring 41 on the first axial side to the surface S1
Thickness tb: the thickness from the surface of the metal ring 41 on the second axial side to the surface S2
Thickness tc: the thickness from the surface of the metal ring 41 on the second axial side to the surface S3

When the ninth portion 42f of the rubber 42 is present, the thickness ta is substantially the thickness of the ninth portion 42f. When the ninth portion 42f is not present, the thickness ta is substantially zero. The thickness ta is smaller than the thickness tb. Further, the thickness ta and the thickness tb are smaller than the thickness tc.

As shown in FIG. 3, the sliding member 15 includes a “surface S4,” a “surface S5,” and a “surface S6” defined below.
Surface S4: the surface of the eleventh portion (first rubber portion) 42b3 of the rubber 42 on the first radial side or the surface of the cylindrical portion 41b of the metal ring 41 on the first radial side (when the eleventh portion 42b3 is not present)
Surface S5: the surface of the third portion (second rubber portion) 42a3 of the rubber 42 on the second radial side and/or the surface of the third portion (sheet portion) 44b of the sheet 43 on the second radial side
Surface S6: the surface of the tenth portion (third rubber portion) 42b2 of the rubber 42 on the first radial side

As shown in FIG. 3, the sliding member 15 includes a “thickness td,” a “thickness te,” and a “thickness tf” defined below.
Thickness (first thickness) td: the thickness from the outer circumferential surface of the cylindrical portion 41b of the metal ring 41 to the surface S4
Thickness (second thickness) te: the thickness from the inner circumferential surface of the cylindrical portion 41b of the metal ring 41 to the surface S5
Thickness (third thickness) tf: the thickness from the outer circumferential surface of the cylindrical portion 41b of the metal ring 41 to the surface S6

When the eleventh portion 42b3 of the rubber 42 is present, the thickness td is substantially the thickness of the eleventh portion 42b3. When the eleventh portion 42b3 of the rubber 42 is not present, the thickness td is substantially zero. The thickness td is smaller than the thickness te. The thickness td is smaller than the thickness tf. The thickness te and the thickness tf may be the same or different. In the present embodiment, the thickness te is larger than the thickness tf.

Since the rubber 42 has higher rigidity than the sheet 43, the shape of the sheet 43 is maintained by the rubber 42. The shape of the middle portion 44 of the sheet 43 is also maintained by the metal ring 41.

The sheet 43 is made of the nonwoven or woven fabric made of the conductive fibers. The sheet 43 includes the gaps in a material state prior to the manufacture of the sliding member 15. After the manufacture of the sliding member 15, the rubber 42 is also present in the gaps in the sheet 43. As described later, the sliding member 15 is manufactured by inserting the metal ring 41 and the sheet 43 into a die, vulcanizing a rubber material that constitutes the rubber 42 and molding it into a predetermined shape, and bonding the rubber material to the metal ring 41 and the sheet 43. Hereinafter, this manufacturing process will also be referred to as “vulcanization bonding.” During the vulcanization bonding, the rubber 42 enters the gaps in the sheet 43. During the vulcanization bonding, the rubber 42 is easily bonded to the binder.

The fixed portion 45 of the sheet 43 is exposed on the surface of the sliding member 15 and is in contact with the annular groove 23 of the outer ring 11. The sliding portion 46 of the sheet 43 is exposed on the surface of the sliding member 15 and is in contact with the sliding member contact surface 33 of the inner ring 12. The plurality of conductive fibers that constitutes the sheet 43 is in contact with one another, and the sheet 43 has electrical conductivity from the fixed portion 45 to the sliding portion 46 due to the contact between the conductive fibers. Since the sheet 43 is in contact with the outer ring 11 and the inner ring 12, the outer ring 11 and the inner ring 12 are electrically connected via the sheet 43. The rubber 42 having electrical conductivity is in contact with the sheet 43 and also with the metal ring 41. The outer ring 11 and the inner ring 12 are electrically connected via the sheet 43 as well as the metal ring 41 and the rubber 42 having electrical conductivity.

Therefore, the sliding member 15 of the present embodiment can release electric charge from one of the fixed portion 45 and the sliding portion 46 to the other. Further, the sliding member 15 of the present embodiment can release electric charge from one of the member that fixes the fixed portion 45 and the member on which the sliding portion 46 slides to the other. The rolling bearing 10 of the present embodiment can release electric charge from one of the outer ring 11 and the inner ring 12 to the other via the sliding member 15, thereby suppressing electrolytic corrosion of the balls 13 and the outer ring raceway 21 and the inner ring raceway 31 along which the balls 13 roll.

As shown in FIG. 2, the sheet 43 is disposed at the extremity of the sliding member 15 on the second axial side (intra-bearing space K1 side). The sliding member contact surface 33 provided on the inner ring 12 is a surface oriented to the first axial side (extra-bearing space K2 side). Therefore, the sliding portion 46 of the sheet 43 can easily be brought into contact with the sliding member contact surface 33. When the sliding member contact surface 33 is a surface oriented to the second axial side, however, the sheet 43 of the sliding member 15 may be positioned at the extremity of the sliding member 15 on the first axial side.

### [Method for Manufacturing Sliding Member]

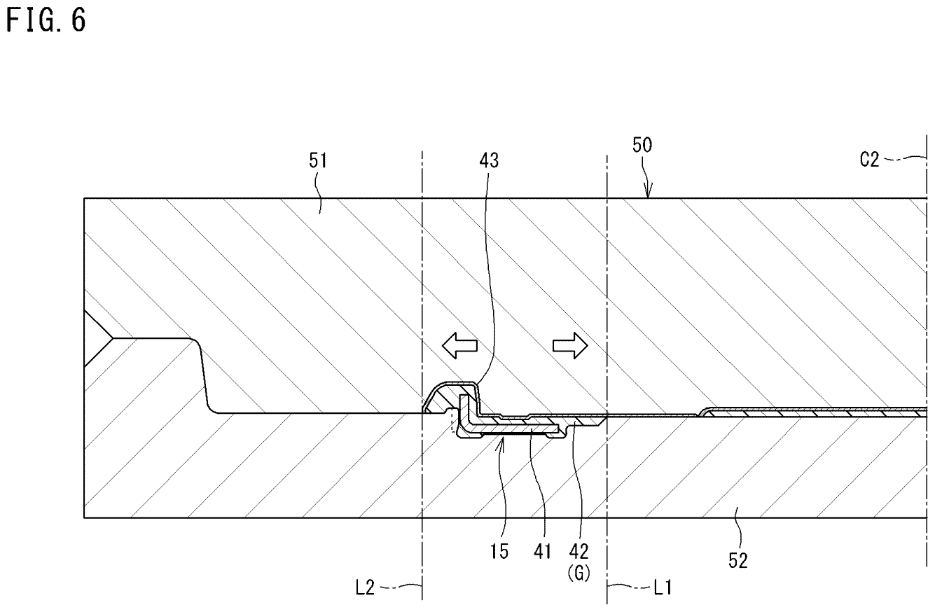

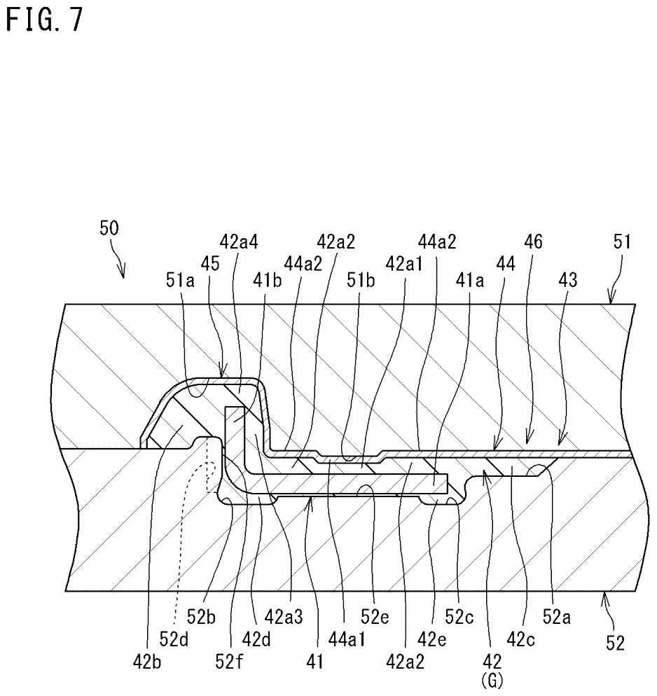

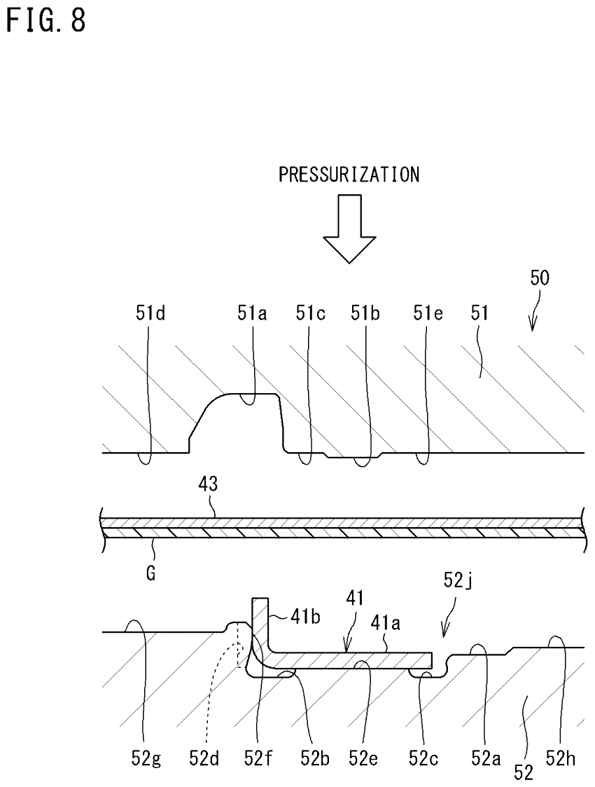

FIG. 6 is a sectional view showing a molding die for the sliding member. FIG. 7 is an enlarged sectional view showing part of the molding die for the sliding member. FIG. 8 is an enlarged sectional view showing part of the molding die in an open state. The sliding member 15 is manufactured by compression molding (pressure molding) using a molding die 50. The molding die 50 for the sliding member 15 includes an upper die 51 and a lower die 52. As shown in FIG. 8, the upper die 51 includes a recess 51a, a protrusion 51b, an annular surface 51c, an annular surface 51d, and an annular surface 51e. The annular surfaces 51c, 51d, 51e are surfaces oriented to the lower die 52. The recess 51a is recessed from the annular surface 51c on the radially inner side relative to the recess 51a and the annular surface 51d on the radially outer side relative to the recess 51a. The protrusion 51b protrudes from the annular surface 51e on the radially inner side relative to the protrusion 51b and the annular surface 51c on the radially outer side relative to the protrusion 51b. The lower die 52 includes recesses 52a, 52b, 52c, 52d, a placement surface 52e, an annular surface 52g, and an annular surface 52h. The recesses 52a, 52b, 52c, 52d and the placement surface 52e are recessed integrally from the annular surface 52g and the annular surface 52h. The recesses 52a, 52b, 52c, 52d and the placement surface 52e are collectively referred to as a recess 52j.

The recesses 51a, 52a, 52b, 52c, the placement surface 52e, and the protrusion 51b have annular shapes about an axis C2. The recesses 52d of the lower die 52 are present at a plurality of positions with spacings in a circumferential direction about the axis C2. The protrusion 51b of the upper die 51 enters the recess 52j of the lower die 52. The recesses 52b, 52c of the lower die 52 are formed by digging further down from the bottom surface of the recess 52a.

The recess 51a is positioned on the radially inner side relative to the annular surface 51d and on the radially outer side relative to the annular surface 51c. The protrusion 51b is positioned on the radially inner side relative to the annular surface 51c and on the radially outer side relative to the annular surface 51e.

The recesses 52d are positioned on the radially inner side relative to the annular surface 52g and on both circumferential sides of part of the annular surface 52g, and are positioned on the radially outer side relative to the recess 52b. The recess 52b is positioned on the radially inner side relative to part of the annular surface 52g and the recesses 52d, and is positioned on the radially outer side relative to the placement surface 52e. The placement surface 52e is positioned on the radially inner side relative to the recess 52b and on the radially outer side relative to the recess 52c. The recess 52c is positioned on the radially inner side relative to the placement surface 52e and on the radially outer side relative to the recess 52a. The recess 52a is positioned on the radially inner side relative to the recess 52c and on the radially outer side relative to the annular surface 52h.

In the lower die 52, the placement surface 52e protrudes toward the upper die 51 from the recess 52b, and protrudes toward the upper die 51 from the recess 52c. The surface of the annular portion 41a of the metal ring 41 on the first axial side is placed on the placement surface 52e. In the lower die 52, regulating surfaces 52f are each provided between the circumferentially adjacent recesses 52d. The outer circumferential surface of the cylindrical portion 41b of the metal ring 41 comes into contact with the regulating surfaces 52f, thereby positioning the metal ring 41 in the radial direction.

An adhesive is applied to the surface of the metal ring 41. For example, the metal ring 41 is immersed in the adhesive, and the adhesive is applied to the surface of the metal ring 41. The metal ring 41 to which the adhesive is applied is placed on the placement surface 52e. As shown in FIG. 8, the metal ring 41, the sheet 43, and an unvulcanized rubber material G are placed between the upper die 51 and the lower die 52 that are separated and open. The unvulcanized rubber material G is formed into a sheet shape. The sheet 43 and the rubber material G are placed between the upper die 51 and the lower die 52 while being laid one on top of the other. The unvulcanized rubber material G has high adhesiveness, and is therefore bonded to the sheet 43 by being laid on the sheet 43. This suppresses misalignment between the sheet 43 and the rubber material.

The recess 51a of the upper die 51 and the annular surface 52g, the recesses 52d, and the recess 52b of the lower die 52 mold the third portion 42a3, the fourth portion 42a4, the fifth portion 42b, the tenth portion 42b2, the eleventh portion 42b3, and the seventh portion 42d of the rubber 42 shown in FIG. 2. The third portion 44b, the fourth portion 44c, the fifth portion 45a, and the sixth portion 45b of the sheet 43 enter the recess 51a, and are molded into a shape conforming to the inner surface of the recess 51a.

The recess 52j of the lower die 52 and the annular surface 51c, the protrusion 51b, and the annular surface 51e of the upper die 51 mold the first portion 42a1, the second portions 42a2, the sixth portion 42c, the eighth portion 42e, the ninth portion 42f, and the radially inner side of the seventh portion 42d of the rubber 42 shown in FIG. 2. The first portion 44a1, the second portions 44a2, and the sliding portion 46 of the sheet 43 are sandwiched between the first portion 42a1, the second portions 42a2, and the sixth portion 42c of the rubber 42 and the annular surface 51c, the protrusion 51b, and the annular surface 51e of the upper die 51, and are molded into a shape conforming to the annular surface 51c, the protrusion 51b, and the annular surface 51e. Therefore, shapes corresponding to the shapes of the annular surface 51c, the protrusion 51b, and the annular surface 51e of the upper die 51 are formed on the rubber 42 and the sheet 43. The recess 52b of the lower die 52 is a portion for molding the seventh portion 42d of the rubber 42 shown in FIG. 2. The recess 52c is a portion for molding the eighth portion 42e of the rubber 42. The recesses 52d are portions for molding the tenth portion 42b2 of the rubber 42.

The sliding member 15 is manufactured by placing the metal ring 41, the sheet 43, and the unvulcanized rubber material G between the upper die 51 and the lower die 52, closing the upper die 51 and the lower die 52, and applying pressure and heat. The pressurized unvulcanized rubber material G flows inside the die 50 and fills the recesses 51a, 52a to 52d of the upper die 51 and the lower die 52. The unvulcanized rubber material G also enters the gaps in the sheet 43. When heated in this state, the adhesive is cured and the unvulcanized rubber material G turns into the rubber 42. When the adhesive is cured and the unvulcanized rubber material G turns into the vulcanized rubber 42, the metal ring 41, the sheet 43, and the rubber 42 are integrated together. The integrated piece turns into the sliding member 15 by cutting off unnecessary portions. For example, the sliding member 15 is obtained by cutting the rubber 42 and the sheet 43 along cutting lines L1, L2 shown in FIG. 6. By causing the unvulcanized rubber material G to enter the sheet 43 and vulcanizing it, the rigidity of the sheet 43 is increased and the sheet 43 and the rubber 42 are integrated together.

In the above manufacturing method, the metal ring 41 is positioned in the up-down direction by being placed on the placement surface 52e of the lower die 52. The spacing in the up-down direction between the metal ring 41 and the upper die 51 is narrowed by the protrusion 51b of the upper die 51, and the metal ring 41 is held from above by the protrusion 51b via the sheet 43 and the rubber 42 (rubber material G). This restrains the metal ring 41 from being lifted from the placement surface 52e. Further, the metal ring 41 is positioned in the radial direction by the regulating surfaces 52f of the lower die 52.

When the sliding member 15 is molded by the die 50, the rubber material G flows in the radial direction as shown by outline arrows in FIG. 6. Therefore, the metal ring 41 is likely to move in the radial direction inside the die 50. Due to the flow of the rubber material G, the rubber material G is likely to flow between the placement surface 52e and the annular portion 41a of the metal ring 41, and the metal ring 41 is likely to be lifted. The die 50 of the present embodiment can position the metal ring 41 at an accurate position and restrict the movement of the metal ring 41 by the placement surface 52e, the regulating surfaces 52f, and the protrusion 51b. Therefore, the rubber 42 and the sheet 43 are fixed at appropriate positions relative to the metal ring 41. The sheet 43 is placed in the die 50 along the upper die 51, and the rubber material G placed on the metal ring 41 side of the sheet 43 moves toward the metal ring 41 without breaking the sheet 43. Therefore, the rubber material G does not break the sheet 43 and the loss of electrical conductivity can be prevented.

When the sliding member 15 is molded inside the die 50, a small amount of the rubber material G enters the space between the lower surface of the metal ring 41 and the placement surface 52e to form a thin film-shaped portion (ninth portion) 42f (see FIG. 2). A small amount of the rubber material G also enters the space between the outer circumferential surface of the metal ring 41 and the regulating surfaces 52f to form a thin film-shaped portion (eleventh portion) 42b3. However, these portions 42f, 42b3 need not essentially be formed. When these portions 42f, 42b3 are not formed, the surface of the metal ring 41 is exposed to the outside.

The sliding member 15 according to the embodiment described above includes the metal ring 41, the rubber 42, and the sheet 43 as shown in FIG. 2. The sheet 43 is made of the conductive fibers, is fixed in contact with the first member (outer ring 11) made of the steel material, and is in slidable contact with the second member (inner ring 12) made of the steel material.

The metal ring 41 includes a first circumferential surface (outer circumferential surface of the cylindrical portion 41b) disposed to be oriented to the first radial side and extending in the axial direction, and a second circumferential surface (inner circumferential surface of the cylindrical portion 41b) disposed to be oriented to the second radial side and extending in the axial direction. The rubber 42 includes the first rubber portion (eleventh portion) 42b3 fixed to the first circumferential surface, and the second rubber portion (third portion) 42a3 fixed to the second circumferential surface. The sliding member 15 includes at least the second rubber portion 42a3 out of the first rubber portion 42b3 and the second rubber portion 42a3.

The sheet 43 includes the sheet portion (third portion of the middle portion 44 of the sheet 43) 44b fixed to the second rubber portion 42a3.

In the sliding member 15, the first surface S4 on the first radial side is the first circumferential surface of the metal ring 41 or the surface of the first rubber portion 42b3 on the first radial side, and the second surface S5 on the second radial side is the surface of the second rubber portion 42a3 on the second radial side and/or the surface of the sheet portion 44b on the second radial side. In the sliding member 15, the first thickness td is the thickness from the first circumferential surface of the metal ring 41 (outer circumferential surface of the cylindrical portion 41b) to the first surface S4, and the second thickness te is the thickness from the second circumferential surface of the metal ring 41 (inner circumferential surface of the cylindrical portion 41b) to the second surface S5. The second thickness te is larger than the first thickness td.

Therefore, in the sliding member 15 according to the embodiment, the sheet 43 that is the nonwoven or woven fabric made of the conductive fibers can have a smaller electrical resistance and a higher electrical conductivity than an elastic member in which carbon fibers are kneaded into rubber. Thus, the sliding member 15 electrically connects the first member 11 and the second member 12 via the sheet 43, and a current can flow from one of the first member 11 and the second member 12 to the other via the sheet 43.

In the sliding member 15, the second thickness te is larger than the first thickness td. The die 50 for molding the sliding member 15 having such a configuration has a structure (regulating surfaces 52f) for regulating the position of the metal ring 41 from the first radial side as shown in FIG. 8. Thus, it is possible to suppress misalignment of the metal ring 41 relative to the die 50 in the radial direction.

The rubber 42 of the sliding member 15 according to the above embodiment includes the first rubber portions (eleventh portions) 42b3 fixed to the first circumferential surface of the metal ring 41 (outer circumferential surface of the cylindrical portion 41b) and disposed at spacings in the circumferential direction, the second rubber portion (third portion) 42a3 fixed to the second circumferential surface (inner circumferential surface of the cylindrical portion 41b), and the plurality of third rubber portions (tenth portions) 42b2 each fixed to the first circumferential surface of the metal ring 41 between the circumferentially adjacent first rubber portions 42b3. The sliding member 15 includes at least the second rubber portion 42a3 and the third rubber portions 42b2 out of the first rubber portions 42b3, the second rubber portion 42a3, and the third rubber portions 42b2.

In the sliding member 15, the first surface S4 on the first radial side is the first circumferential surface of the metal ring 41 or the surface of the first rubber portion 42b3 on the first radial side, and the second surface S5 on the second radial side is the surface of the second rubber portion 42a3 on the second radial side and/or the surface of the sheet portion 44b on the second radial side. The third surface S6 on the first radial side is the surface of the third rubber portion 42b2 on the first radial side. In the sliding member 15, the first thickness td is the thickness from the first circumferential surface of the metal ring 41 (outer circumferential surface of the cylindrical portion 41b) to the first surface S4, the second thickness te is the thickness from the second circumferential surface of the metal ring 41 (inner circumferential surface of the cylindrical portion 41b) to the second surface S5, and the third thickness tf is the thickness from the first circumferential surface of the metal ring 41 to the third surface S6. The second thickness te is larger than the first thickness td, and the third thickness tf is larger than the first thickness td.

The die 50 for molding the sliding member 15 having such a configuration has a structure (regulating surfaces 52f) for regulating the position of the metal ring 41 from the first radial side partially in the circumferential direction as shown in FIG. 8. Thus, it is possible to suppress misalignment of the metal ring 41 relative to the die 50 in the radial direction. Since the rubber 42 is bonded to the entire sheet 43 on the first axial side, the overall shape of the sheet 43 can be maintained by the rubber, and the sheet is not broken during the manufacture. Therefore, the loss of electrical conductivity can be prevented.

### Other Embodiments

In the rolling bearing 10 of the above embodiment, the outer ring 11 is the fixed ring, and the inner ring 12 is the rotary ring. In the present invention, the outer ring 11 may be a rotary ring, and the inner ring 12 may be a fixed ring.

The sliding member 15 of the above embodiment is fixed to the outer ring 11 that is the first member, and is in slidable contact with the inner ring 12 that is the second member. In the present invention, the sliding member 15 may be fixed to the inner ring 12 that is the first member, and may be in slidable contact with the outer ring 11 that is the second member.

In the sliding member 15 of the above embodiment, the synthetic resin serving as the binder is fixed to the conductive fibers that constitute the sheet 43. The sheet of the present invention need not contain the synthetic resin as the binder in the conductive fibers that constitute the sheet. The sliding member 15 of the above embodiment is used in the rolling bearing 10. However, the sliding member 15 of the present invention may be used in a device in which it is fixed to one of two members that move relatively and is in slidable contact with the other member.

In the above embodiment, the rolling bearing 10 is the deep groove ball bearing. In the present invention, however, the rolling bearing 10 may be an angular contact ball bearing, a roller bearing in which the rolling elements are rollers, etc. The above embodiment is illustrative in all respects and not restrictive. The scope of the present invention is shown by the claims rather than by the above embodiment, and is intended to include all modifications within the scope equivalent to that of the configurations described in the claims.

### DESCRIPTION OF THE REFERENCE NUMERALS

10 . . . rolling bearing, 11 . . . outer ring, 11 . . . first member, 12 . . . inner ring, 12 . . . second member, 13 . . . rolling element, 15 . . . sliding member, 21 . . . outer ring raceway, 31 . . . inner ring raceway, 41 . . . metal ring, 42 . . . rubber, 42a3 . . . fourth portion (second rubber portion), 42b2 . . . tenth portion (third rubber portion), 42b3 . . . eleventh portion (first rubber portion), 43 . . . sheet, 44b . . . third portion (sheet portion), S4 . . . surface (first surface), S5 . . . surface (second surface), S6 . . . surface (third surface), td . . . thickness (first thickness), te . . . thickness (second thickness), tf . . . thickness (third thickness)

1.-5. (canceled)

6. A sliding member comprising:
a sheet;
a metal ring; and
a rubber, wherein
the sheet is made of conductive fibers, is fixed in contact with a first member made of a steel material, and is in slidable contact with a second member made of a steel material,
the metal ring includes a first circumferential surface disposed to be oriented to a first radial side and extending in an axial direction, and a second circumferential surface disposed to be oriented to a second radial side and extending in the axial direction,
the rubber includes at least a second rubber portion out of:
a first rubber portion fixed to the first circumferential surface; and
the second rubber portion fixed to the second circumferential surface,
the sheet includes a sheet portion fixed to the second rubber portion,
a first surface on the first radial side is the first circumferential surface or a surface of the first rubber portion on the first radial side,
a second surface on the second radial side is a surface of the second rubber portion on the second radial side and/or a surface of the sheet portion on the second radial side,
a first thickness is a thickness from the first circumferential surface to the first surface,
a second thickness is a thickness from the second circumferential surface to the second surface,
the second thickness is larger than the first thickness,
the metal ring is disposed at a spacing from the sheet on a first axial side, and
the rubber includes a portion disposed in the spacing.

7. The sliding member according to claim 6, wherein the rubber is bonded to an entirety of the sheet on the first axial side.

8. A rolling bearing comprising:
an inner ring including an inner ring raceway;
an outer ring including an outer ring raceway disposed on a radially outer side relative to the inner ring raceway;
a plurality of rolling elements rotatably disposed between the inner ring raceway and the outer ring raceway; and
the sliding member according to claim 6 that is disposed between an axial end of the inner ring and an axial end of the outer ring in a radial direction, wherein
one of the inner ring and the outer ring is the first member, and
the other of the inner ring and the outer ring is the second member.

9. A sliding member comprising:
a sheet;
a metal ring; and
a rubber, wherein
the sheet is made of conductive fibers, is fixed in contact with a first member made of a steel material, and is in slidable contact with a second member made of a steel material,
the metal ring includes a first circumferential surface disposed to be oriented to a first radial side and extending in an axial direction, and a second circumferential surface disposed to be oriented to a second radial side and extending in the axial direction,
the rubber includes at least a second rubber portion and a plurality of third rubber portions out of:
a plurality of first rubber portions fixed to the first circumferential surface and disposed at spacings in a circumferential direction;
the second rubber portion fixed to the second circumferential surface; and
the third rubber portions each fixed to the first circumferential surface between the circumferentially adjacent first rubber portions,
the sheet includes a sheet portion fixed to the second rubber portion,
a first surface on the first radial side is the first circumferential surface or a surface of each of the first rubber portions on the first radial side,
a second surface on the second radial side is a surface of the second rubber portion on the second radial side and/or a surface of the sheet portion on the second radial side,
a third surface on the first radial side is a surface of each of the third rubber portions on the first radial side,
a first thickness is a thickness from the first circumferential surface to the first surface,
a second thickness is a thickness from the second circumferential surface to the second surface,
a third thickness is a thickness from the first circumferential surface to the third surface,
the second thickness is larger than the first thickness, and
the third thickness is larger than the first thickness.

10. The sliding member according to claim 9, wherein:
the metal ring is disposed at a spacing from the sheet on a first axial side; and
the rubber includes a portion disposed in the spacing.

11. The sliding member according to claim 9, wherein the rubber is bonded to an entirety of the sheet on a first axial side.

12. A rolling bearing comprising:
an inner ring including an inner ring raceway;
an outer ring including an outer ring raceway disposed on a radially outer side relative to the inner ring raceway;
a plurality of rolling elements rotatably disposed between the inner ring raceway and the outer ring raceway; and
the sliding member according to claim 9 that is disposed between an axial end of the inner ring and an axial end of the outer ring in a radial direction, wherein
one of the inner ring and the outer ring is the first member, and
the other of the inner ring and the outer ring is the second member.
